(19) United States
(12) Patent Application Publication
(10) Pub. No.: US 2003/0041876 A1
(43) Pub. Date: Mar. 6, 2003

(54) Method and device for removing particles on semiconductor wafers

(76) Inventors: Toshihito Tsuga, Tsuchiura-shi (JP); Minoru Fube, Hayami-gun (JP); Kazutaka Nakayama, Hayami-gun (JP)

Correspondence Address: TEXAS INSTRUMENTS INCORPORATED, P O BOX 655474, M/S 3999, DALLAS, TX, 75265

(21) Appl. No.: 10/085,725

(22) Filed: Feb. 28, 2002

(30) Foreign Application Priority Data
Mar. 5, 2001 (JP) 13(2001)-59777

(51) Int. Cl. B08B 3/12

(52) U.S. Cl. 134/1.3; 134/26; 134/36; 134/184; 134/902

(57) ABSTRACT

A method for removing particles on semiconductor wafers, which is a process involving a cleaning tank filled with a first cleaning solution consisting of hydrogen water, is accomplished by carrying out said process in which in-solution hydrogen concentration in said first cleaning solution is in the range 20% to 50% of its saturated concentration (0.3 ppm to 0.8 ppm), a process in which ultrasonic waves are generated in said semiconductor wafers are cleaned for a prescribed time in said cleaning tank. Here the in-solution hydrogen concentration in said first cleaning solution is in the range 0.3 ppm to 0.8 ppm.

### TECHNICAL FIELD TO WHICH THE INVENTION BELONGS

This invention concerns a method and device for cleaning semiconductor wafers; in particular, it concerns a method and device for removing particles that adhere to the suface of semiconductor wafers.

### CROSS REFERENCES TO RELATED APPLICATIONS

### BACKGROUND OF THE INVENTION

[Proir Art]

The requirement for greater intergration and higher density of semiconductor devices has brought with it ever more-stringent requirements for the degree of cleanliness against fine impurities on the surface of semiconductor wafers. Therefore in order to raise the manufacturing yield for semiconductor chips, it is necessary to remove impurities effectively by cleaning the semiconductor wafer.

The cleaning of semiconductor wafers includes multiple processes for removing from the surface of the semiconductor wafer fine particles consisting of many types of impurities, such as metal impurities, organic impurities, or silicon. In the cleaning process, semiconductor wafers are successively cleaned in multiple cleaning tasks in which various cleaning solutions circulate. Multiple semiconductor wafers are conveyed held in an arbitrary tray and are placed within a cleaning tank for a preset cleaning time. The following describes a typical cleaning process that is carried out.

(b 1) The semiconductor wafers are conveyed into a cleaning tank of SC-1 (an aqueous solution of ammonia and hydrogen peroxide: NG4OH, H2O2, H2O) and are cleaned for about 10 minutes, mainly for the purpose for removing fine particles on the surfaces of the semiconductor wafers.

(2) Next, in order to rinse off the SC-1 from the surface of the semiconductor wafers, said semiconductor wafers are conveyed into a cleaning tank of ultra-pure water and are rinsed for about 10 minutes.

(3) Next, the semiconductor wafers are conveyed into a cleaning tank of SC-2 (HCl, H2O2, H2O) and are cleaned for about 10 minutes, mainly for the purpose of removing metal impurities and organic impurities on the surface of the semiconductor wafers.

(4) Next, in order to rinse off the SC-2 from the surface of the semiconductor wafers, said semiconductor wafers are conveyed into a cleaning tank of ultra-pure water and are rinsed for about 10 minutes.

(5) Next, said semiconductor wafers are conveyed into a cleaning tank of a mixed solution of hydrogen fluoride (a cleaning solution of dilute HF, FPM (HF,H2O2, H2O), etc.) and are cleaned for 1-5 minutes, mainly for the purpose of removing silicon oxide film (natural oxide film) on the surface of the semiconductor wafers.

6) As the final process, in order to rinse off the HF (hydrogen fluoride) mixed solution, said semiconductor wafers are conveyed into a cleaning tank of ultra-pure water and are rinsed for about 10 minutes.

[Problems the the Invention is to Solve]

But because a large quantity of chemicals are used typical cleaning process, it has been pointed out that the cost of consumables and the cost of treating the effluent is enormous, and curtailing these costs is strongly desired.

Against this background, research has widely been carried out into new cleaning methods employed cleaning solutions to replace these chemicals, and as one result of this research, a method has been newly proposed in which hydrogen water is used as the cleaning solution instead of the SC-1 currently used mainly for the purpose of removing fine particles on the surface of the semiconductor wafers, and ultrasonic vibration is applied to it. And according to the results of previous research, in order to increase the proportion of particles on the wafer surface that are removed, it had been held good to set the in-solution concentration of the hydrogen water used in this cleaning to at least 1.0 ppm, as shown in the following graph.

[image]

But the results in the above graph were obtained in so-called Hiraha-type cleaning, in which cleaning is done by spraying hydrogen water onto revolving silicon wafers from nozzles, and it has been revealed in experiments by the inventors that if this is done in the above-described batch-type cleaning, in which the cleaning is done by immersing multiple silicon wafers in cleaning tanks, there is the problem that sufficient particle removal ability cannot be obtained. Therefore as long as hydrogen water is used in the above in-solution range of concentration, it is difficult to do cleaning using hydrogen water instead of cleaning using SC-1.

Therefore the purpose of this invention is to optimize the in-solution concentration of the hydrogen water used in so-called batch-type cleaning, hydrogen water cleaning instead of cleaning with SC-1.

[Means of Solving the Problems]

The method of this invention for removing particles on semiconductor wafers has a first cleaning process in which semiconductor wafers are cleaned for a prescribed time by immersing them in a first cleaning solution consisting of ultra-pure water containing a prescribed gas in a range 20% to 50% of the saturated concentration in a first cleaning tank, and ultrasonic waves are supplied to said first cleaning solution in said first process. Here, the prescribed gas in said first cleaning solution is preferalby hydrogen, and its in-solution concentration of hydrogen is in the range 0.3 ppm to 0.8 ppm.

Heretofore, if hydrogen water (ultra-pure water containing a prescribed quantity of hydrogen) was to be used for cleaning to remove particles, it was considered good to have the in-solution concentration of the hydrogen be as high as possible (1.0 ppm or more), but experiments by the inventors have shown that very good results are obtained at hydrogen concentrations in the above range in the so-called batch-processing cleaning to which this invention applies. Properly speaking, the ultrasonic waves that are supplied into the hydrogen water are thought to function so as to remove the particles on the surface of the silicon wafers by the physical impact force due to their cavitation effect, but if the in-solution hydrogen concentration is increased to near its saturated concentration, bubbles readily occur inside the cleaning tank, and this is thought to instead reduce the ability to remove particles. That is, it is thought that because of the increase in bubbles, some of them adhere to the silicon wafer surface by surface tension and linger there which actually adsorbs particles in the hydrogen water, and the large number of bubbles impede the energy propagation of the ultrasonic waves and reduce the (physical) impact force due to the cavitation effect on the silicon wafer surface. Therefore, by the above experiments, control of the bubbles is possible, and it is very effective for particle removal to use hydrogen water of 0.3 ppm to 0.8 ppm, which is 20% to 50% of the saturated in-solution hydrogen concentration, as the range of concentration that effectively links the cavitation effect due to the utrasonic waves to particle removal.

Also, it is desirable that said first cleaning solution contain ammonia in an in-solution concentration in the range 1 ppm to 10 ppm.

In addtion, it is desirable that it have, before said first cleaning process, a second cleaning process in which the semiconductor wafers are cleaned for a prescribed time by immersing them in a second cleaning solution consisting of ultra-pure water containing a prescribed quantity of ozone in a second cleaning tank.

If cleaning with ozone water (ultra-pure water containing a prescribed quanity of ozone) is done prior to cleaning with hydrogen water, an oxide film is formed on the surface of the semiconductor wafer in said stage of cleaning with ozone water, resulting in a condition in which particles on the wafer surface adhere to the oxide film. As has long been known, the electric potential sign of the oxide film and the particles to the semiconductor wafer surface before an oxide film is formed. As a result, the removal of particle on the surface can be very effectively done in the cleaning not of silicon oxide film wafers but also of bare-silicon wafers.

Also, it is desirable that it have, after said second cleaning process, a third cleaning process in which said semiconductor wafers are cleaned for a prescribed time by immersing them in a third cleaning solution consisting of HF mixed solution in a third cleaning tank.

Also the device of this invention for remove particles on semiconductor wafers has a first cleaning tank filled with ultra-pure water containing hydrogen in the range 20% to 50% of the saturated concentration, an ultrasonic wave supply means for supplying ultrasonic waves to said first cleaning solution in said first cleaning tank, and a control means that controls said conveyance means so as to immerse the semiconductor wafers in said cleaning solution in said first cleaning tank, and after a prescribed time remove said semiconductor wafers from said first cleaning solution.

### BRIEF EXPLANATION OF THE DRAWINGS

FIG. 1 This is a diagram that shows conceptually the process of this invention for the cleaning processes for removing particles.

FIG. 2 This is a diagram that outlines the compostion of a hydrogen water supply device.

FIG. 3 This is a control block diagram for implementing the cleaning processes of this invention.

### Explanation of the Symbols

100 silicon wafers

102 tray

104 ozone water cleaning tank

108 ultrasonic wave vibrators

200 hydrogen water supply device

202 water path

204 degassing cylinder

206 gas dissolving module

302 wafer detection sensor

304 sequencer

306 timer

308 transmission circuit

310 ultrasonic vibrators

312 conveyance drive unit

314 conveyance crane

### DETAILED DESCRIPTION OF THE PREFERRED EMBODIMENTS

[Detailed Description of the Preferred Embodiments]

In the following, a detailed description of this invention is given, based on an embodiment illustrated in the drawings. The method of this invention for removing particles on semiconductor wafers is preferaly used to replace the cleaning process for removing particles by SC-1 in the aforementioned typical cleaning processes that removes particles. In this embodiment, we describe an example in which cleaning with ozone water is done before cleaning with hydrogen water with an in-solution hydrogen concentration according to this invention.

Multiple silicon wafers 100 are held upright in an arbitrary tray 102, and a conveyance crane not pictured here conveys them between the cleaning tanks where the cleaning processes are carried out. In carrying out the particle removal processes of this invention, cleaning tank 104, which contains ozone water, and cleaning tank 106, which contains hydrogen water, are provided. The silicon wafers 100 in said tray 102 are first introduced into cleaning tank 104 containing ozone water and undergo cleaning here for 3-20 minutes, preferably 10 minutes, then are introduced into cleaning tank 106 containing hydrogen water and undergo cleaning here for 3-20 minutes, preferably 10 minutes.

Put into cleaning tank 104 is ozone water, that is, ultra-pure water (UPW) to which a prescribed quanlity of ozone gas has been added. In the preferred embodiment, the in-solution concentration of the ozone gas is 2 ppm to 20 ppm. At least while silicon wafers 100 are in the cleaning tank, ozone wafer is continuouslu supplied in cleaning tank 104 by a supply means not pictured. Silicon wafers 100 are introduced into said cleaning tank 104 by a conveyance crane not pictured, and are kept here for a prescribed time. In this process of this invention for particle removal, the surface fo each silicon wafer 100 is exposed to ozone wafer, and a silicon oxide film (SiO2) is thereby formed on its surface. The thickness of the oxide film if cleaning with ozone water is done for 10 minutes is 8-12 Angstrom units. About 1 ppm to 500 ppm if hydrochloric acid may be added to said ozone water in order to promote the metal impurities removal efficiency.

Put into cleaning tank 106 is hydrogen water, that is, ultra-pure water (UPW) to which a prescribed quantity of hydrogen gas has been added. In the preferred embodiment, the in-solution concentration of hydrogen gas is 0.3 ppm to 0.8 ppm. This corresponds to 20% to 50% of the saturated concentration of hydrogen gas. At least while silicon wafers 100 are in the cleaning tank, hydrogen water is continuously supplied in cleaning tank 106 by a supply—that is radiate—ultrasonic waves of a prescribed frequency to the hydrogen water in cleaning tank 106. The irradiation with ultrasonic waves may begin either before or after the silicon wafers are conveyed into cleaning tank 106. Silicon wafers 100, after going through the process of cleaning by said ozone water, are introduced into this hydrogen water cleaning tank 106 and are kept there for a prescribed time. In this cleaning process, particles adhering to the surface of silicon wafers 100 are effectively removed.

Also, between the cleaning with ozone water and the cleaning with hydrogen water, one may clean the silicon wafers 100 with ultra-pure water and rinse away the cleaning solution that came to adhere to the silicon wafers in the ozone water cleaning. In particular, it is desirable to do this if hydrocholoric acid is added to the ozone water.

FIG. 2 outlines the composition of a hydrogen water supply device that generates hydrogen water and supplies it to cleaning tank 106. In the drawing, hydrogen water supply device 200 is constructed with degassing cylinder 204 and gas dissolving module 206 positioned on top of of water path 202, which supplies ultra-pure water to cleaning tank 106. Degassing cylinder 204 is used for removing the nitrogen, oxygen, and other in-solution gas that is contained in the ultra-pure water. Gas dissolving module 206, which is composed using a hollow-thread film module, etc., is for dissolving a prescribed a quantity of hydrogen gas into the ultra-pure water that passes through it, so one generates hydrogen water of the prescribed concentration by introducing flow-controlled hydrogen gas into it and passing ultra-pure water through its gas atmosphere. In the embodiment od this invention, the desirble in-solution hydrogen concentration of the hydrogen water supplied to cleaning tank 106 is 0.3 ppm to 0.8 ppm, that is, 20% to 50% of its saturated concentration. The device that supplies ozone water to cleaning tank 104 may be constituted by an ozone water supply device of the same composition as above (that is, it supplies ozone gas instead of hydrogen gas to the gas dissolving module). It may also be constituted with degassing cylinder 204 removed.

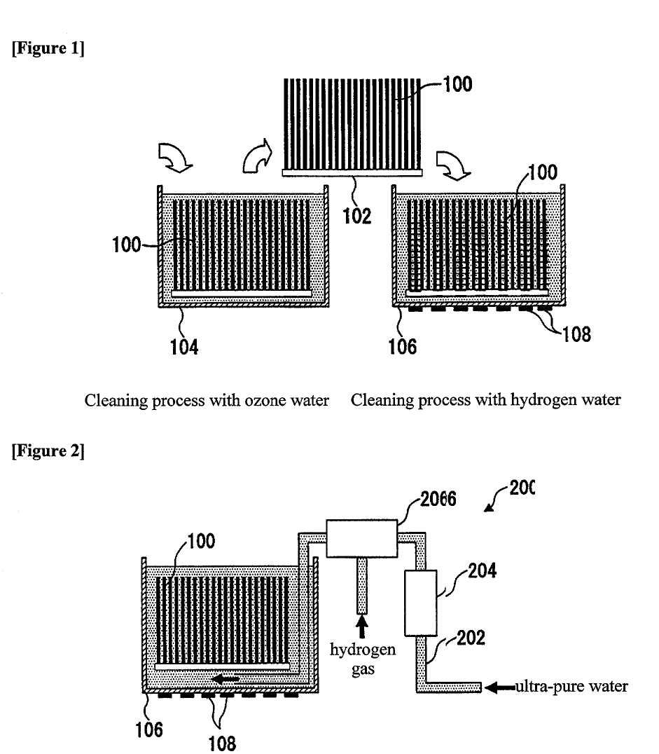

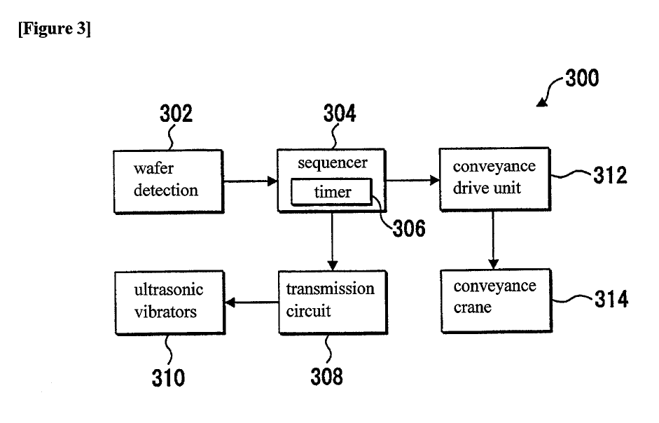

FIG. 3 is control block diagram for implementing the cleaning processes of this invention. In control 300, ultrasonic vibrators 310 and silicon wafer conveyance crane 314 are driven and controlled based on control signals from sequencer 304. Sequencer 304 is equipped with timer 306, and it is activated (set) of stopped (reset) by receiving detection signals from water detection sensor 302. Wafer detection sensor 302 is installed on or in cleaning tanks 104 and 106 in FIG. 1 and detects whether silicon wafers 100 are present inside the cleaning tank. Sequencer 304 monitors the time measured by timer 306 and is constituted so as to output each prescribed control signal when it reaches a preset time. The prescribed control signal from sequencer 304 is given to transmission circuit tank. Also, sequencer 304 emits the prescribed control signal to conveyance drive unit 312, whereby conveyance crane 314 is activated and silicon wafers 100 are conveyed out of cleaning tank 104 and 106.

Control by said control block is begun by wafer detection sensor 302 detecting the conveyance of silicon wafers 100 into cleaning tank 104. That is, when silicon wafers 100 are conveyed into cleaning tank 104 by conveyance crane 314, wafer detection sensor 302 detects this and emits a detection signal to sequencer 304. When sequencer 304 inputs this detection signal, timer 306 is set, and measurement of the time begins. Sequencer 304 monitors the time measured by timer 306 and maintains a wait state, without emitting any control signals, until the reset cleaning time (for example, 10 minutes) elapes. By this process, the surface of the silicon wafer 100 is oxidized, and a silicon oxide film is formed on their surface. The formation of the silicon oxide film on the surface of the silicon wafers creates a states in which the particles that had adhered to said surface adhere to the silicon oxide flim.

When timer 306 measures the set cleaning time and sequencer 304 detects it, sequencer 304 outputs a control signal to move silicon wafer 100 from cleaning tank 104 to the next cleaning tank 106. Conveyance drive unit 312, upon receiving this, activates conveyance crane 314 and conveys silicon wafers 100 out of ozone water cleaning tank 104 and into hydrogen water cleaning tank 106. If, by activation of conveyance crane 314, silicon wafers 100 are properly conveyed out of cleaning tank 104, its wafer detection sensor 302 detects this and emits a detection signal to sequencer 304. When sequencer 304 imputs this detection signal, timer 306 is set once again, and maintains a wait state, without emitting any control signals, until the preset cleaning time (for example. 10 minutes) elapses. And in parallel with the setting of said timer, sequencer 304 outputs a signal to transmission circuit 308 to begin supplying ultrasonic waves. Upon receiving this, transmission circuit 308 excites ultrasonic vibrators 310, which are installed on cleaning tank 106. Thereupon, ultrasonic waves are supplied into cleaning tank 106, promoting the removal of particles on the surface of silicon wafers 100 by the physical impact force due to the cavitation effect.

When sequencer 304 detects that the preset cleaning time has elapsed, it outputs to transmission circuit 308 a signal to terminate the supply of ultrasonic waves. Upon receiving this, transmission circuit 308 terminates the excitation by ultrasonic vibrators 310. In parallel with this, sequencer 304 outputs to conveyance drive unit 312 a control signal to convey silicon wafers 100 out of cleaning tank 106, and thereby conveyance crane 314 is activated and silicon wafers 100 are conveyed out of cleaning tank 106. If, by activation of conveyance crane 314, silicon wafers 100 are properly conveyed out of cleaning tank 106, wafer detection sensor 302 detects this and resets timer 306, resulting in a wait state for the next silicon wafers. With this, the control carried out by the series of cleaning processes comes to an end.

In the preferred embodiment of this invention, a third cleaning process with a HF mixed solution (a cleaning solution of dilute HF, FPM (HF, H2O2, H2O), etc.) is carried out. The third cleaning process, with a HF mixed solution, is carried out, following the above cleaning process with hydrogen water, for the purpose of removing the natural oxide film. The need for this process is high if high device electrical characteristics are required, such as source-drain formation, contact hole formation, or EPI film formation. If cleaning is done with a HF mixed solution, next the cleaning solution is rinsed away with ultra-pure water or hydrogen water (in this case, ultrasonic waves may be supplied). Also, it is desirable to rinse away the cleaning solution of all the ultra-pure water processes prior to this third cleaning process.

### WORKING EXAMPLE 1

The inventors conducted experiments to discover the preferable range of in-solution hydrogen concentration to be used in the hydrogen water cleaning process. According to what was known previously, the in-solution hydrogen concentration of the hydrogen water to be used for cleaning was set to the range 1.0 ppm to 1.6 ppm. But from experiments by the inventors, it was learned that in the batch-type cleaning using cleaning tanks as shown in FIG. 2, particles on the surface of wafers are removed very effectively at an in-solution hydrogen concentration of 0.3 ppm to 0.8 ppm.

In the experiments, samples were made in which about 300-400 particles per 6 inches were intentionally made to adhere onto bare-silicon wafers and silicon oxide film wafers, they were cleaned using hydrogen water of varying in-solution hydrogen water concentrations, and the number of particles remaining after cleaning was measured. The in-solution hydrogen concentration of the hydrogen water was varied between 0 and 1.5 ppm. Also, in each cleaning process, hydrogen water was supplied into an 18.24-liter cleaning tank at a supply quantity of 15.0 liter/min, and the silicon wafers were immersed for 10 minutes in each tank. The ultrasonic wave output was set to 1.0 MHz, 4.1 W/cm2. Measurement of the residual particles was applied to those of size 0.2 μm or larger, using a laser diffusion type particle counter. The experiments were carried out on hydrogen water into which 1 ppm (pH=9.4) ammonia was mixed (Table 3) and on hydrogen water into which none was mixed (Table 4). The results are shown in the following graph.

[image]

[image]

As is clear from the above results, if cleaning is done using hydrogen water having an in-solution hydrogen concentration of 1.0 ppm to 1.6 ppm, which heretofore has been considered the preferable range, a very low particle removal rate is obtained, but if the hydrogen concentration is set to a range of 0.3 ppm to 0.8 ppm, that is, 20% to 50% of its saturated concentration, a very good particle removal rate is shown. Properly speaking, the ultrasonic waves that are generated in the hydrogen water are thought to function so as to remove the particles on the surface of the silicon wafers by the physical impact force due to their cavitation effect, but if the in-solution hydrogen concentration is increased to near its saturated concentration, bubbles readily occur inside the cleaning tank, and this is thought to instead reduce the ability to remove particles. That is, it is thought that because of the increase in bubbles, some of them adhere to the silicon wafer surface by surface tension and linger there, which actually adsorbs particles in the hydrogen water, and the large number of bubbles impede the energy propagation of the ultrasonic waves and reduce the (physical) impact force due to the cavitation effect on the silicon wafer surface. Therefore, by the above experiments, control of the bubbles is possible, and it is very effective for particle removal to use water of 0.3 ppm to 0.8 ppm, which is 20% to 50% of the saturated in-solution hydrogen concentration, as the range of concentration that effectively links the cavitation effect due to the ultrasonic waves to particle removal.

### WORKING EXAMPLE 2

The inventors also carried out experiments to verify the effect if cleaning with ozone water is carried out before said cleaning with hydrogen water, that is, to verify that the same particle removal rate can be achieved in cleaning bare-silicon wafers as for silicon oxide film wafers. In the experiments, about 300-400 particles per 6 inches were intentionally made to adhere onto bare-silicon wafers and silicon oxide film wafers, particle removal was done by the conventional method and by the method of this invention, and the number of particles remaining in each case was measured. The compared cleaning methods are as follows.

Conventional example 1: The case in which cleaning is done by supplying ultrasonic waves to hydrogen water (in-solution concentration: 0.6 ppm)

Conventional example 2: The case in which cleaning is done with ozone water (in-solution concentration: 10 ppm), and rinsing is done with ultra-pure water

Conventional example 3: The case in which cleaning is done by supplying ultrasonic waves to ozone water (in-solution concentration: 10 ppm), and rinsing is done with ultra-pure water

Conventional example 4: The case in which cleaning is done by supplying ultrasonic waves to SC-1 at 40° C., and rinsing is done with ultra-pure water

Conventional example 5: The case in which cleaning is done with SC-1 at 80° C., and rinsing is done with ultra-pure water

Working example 1: The case in which cleaning is done with ozone water (in-solution concentration: 10 ppm), rinsing is done with ultra-pure water, then cleaning is done by supplying ultrasonic waves to hydrogen water (in-solution concentration: 0.6 ppm)

Working example 2: The case in which cleaning is done by supplying ultrasonic waves to ozone water (in-solution concentration: 10 ppm), rinsing is done with ultra-pure water, then cleaning is done by supplying ultrasonic waves to hydrogen water (in-solution concentration: 0.6 ppm)

Working example 3: The case in which cleaning is done with ozone water (in-solution concentration: 10 ppm), cleaning is done by supplying ultrasonic waves to hydrogen water (in-solution concentration: 0.6 ppm), then cleaning is done with HF mixed solution(0.5 wt % HF, 0.5 wt % H2O2), and finally rinsing is done by supplying ultrasonic waves to hydrogen water.

Also, in each cleaning process, cleaning solution was supplied into an 18.24-liter cleaning tank at a supply quantity of 15.0 liter/min, and the silicon wafers were immersed for 10 minutes in each tank. If ultrasonic waves were used, their output was set to 1.0 MHz, 4.1 W/cm2. Measurement of the residual particles was applied to those of size 0.2 μm or larger, using a laser diffusion type particle counter. The results are shown in the following graph.

[image]

From the above results, if cleaning is done with ozone water then cleaning is done with hydrogen water (working examples 1-3), the removal rate for particles adhering to the surface of silicon wafers ((initial number of particles−number of particles after cleaning)/initial number of particles×100) showed a high particle removal rate in the cleaning of both bare-silicon wafers and silicon oxide film wafers, as compared with the case in which only ozone water or only hydrogen water is used (conventional examples 1-3). And in the cases according to the working examples of this invention, even with respect to cleaning using a solution with SC-1 (conventional examples 4 and 5), it showed a particle removal rate of about the same in the cleaning of bare-silicon wafers, and greater in the cleaning of silicon oxide film wafers.

The foregoing has been a description, with diagrams, of an embodiment of this invention. But this invention is not limited to what is shown in the above embodiment, and it is clear that it can be modified or improved based on what appears in the patent claims. As shown by the above experimental results, the particle removal method of this invention can be put to effective use not only in cleaning bare-silicon wafers but also in cleaning silicon oxide film wafers. In the above working examples, hydrogen was taken as an illustration of the in-solution gas in the ultra-pure water, but the in-solution gas is not limited to hydrogen; similar particle removal effect as with hydrogen water can also be obtained with a gas such as nitrogen or argon, provided that the concentration of the in-solution gas is 20% to 50% of its saturated concentration.

### Effects of the Invention

With this invention as described above, in the cleaning of semiconductor wafers with hydrogen water, particle removal can be effectively done by setting its in-solution hydrogen concentration to 0.3 ppm to 0.8 ppm, which is 20% to 50% of its saturated in-solution hydrogen concentration. In particular, according to this invention, by doing ozone water cleaning before the hydrogen water cleaning, a high particle removal rate can be obtained both for silicon oxide film wafers and bare-silicon wafers.

What is claimed:

1. A method for removing particles on semiconductor wafers, comprising the step of performing a first cleaning process in which semiconductor wafers are cleaned for a prescribed time by immersing them in a first cleaning solution comprising ultra-pure water containing a prescribed gas in a range 20% to 50% of the saturated concentration in a first cleaning tank, and in which ultrasonic waves are supplied to said first cleaning solution in said first process.

2. A method for removing particles on semiconductor wafers as described in claim 1 in which said prescribed gas is hydrogen.

3. A method for removing particles on semiconductor wafers as described in claim 2 in which the in-solution concentration of the hydrogen in said first cleaning solution is in the range 0.3 ppm to 0.8 ppm.

4. A method for removing particles on semiconductor wafers as described in claim 2 in which said first cleaning solution contains ammonia in an in-solution concentration in the range 1 ppm to 10 ppm.

5. A method for removing particles on semiconductor wafers as described in claim 2, further comprising the step of, before said first cleaning process, performing a second cleaning process in which the semiconductor wafers are cleaned for a prescribed time by immersing them in a second cleaning solution consisting of ultra-pure water containing a prescribed quantity of ozone in a second cleaning tank.

6. A method for removing particles on semiconductor wafers as described in claim 5 further comprising the step of, after said second cleaning process, performing a third cleaning process in which said semiconductor wafers are cleaned for a prescribed time by immersing them in a third cleaning solution consisting of HF mixed solution in a third cleaning tank.

7. A device for removing particles on semiconductor wafers, comprising:
a first cleaning tank filled with ultra-pure water containing hydrogen in a range 20% to 50% of a saturated concentration;
an ultrasonic wave supply means for supplying ultrasonic waves to said first cleaning solution in said first cleaning tank;
a conveyance means that conveys semiconductor wafers into said first cleaning tank; and
a control means that controls said conveyance means so as to immerse the semiconductor wafers in said first cleaning solution in said first cleaning tank, and after a prescribed time remove said semiconductor wafers from said first cleaning solution.
